(19) United States
(12) Patent Application Publication
(10) Pub. No.: US 2024/0361709 A1
(43) Pub. Date: Oct. 31, 2024

(54) PROCESS CARTRIDGE AND ELECTROPHOTOGRAPHIC APPARATUS

(71) Applicant: CANON KABUSHIKI KAISHA, Tokyo (JP)

(72) Inventors: CHIHARU AKIYAMA, Shizuoka (JP); KANAME WATARIGUCHI, Tokyo (JP); TSUTOMU NISHIDA, Shizuoka (JP)

(21) Appl. No.: 18/646,412

(22) Filed: Apr. 25, 2024

(30) Foreign Application Priority Data
Apr. 28, 2023 (JP) 2023-075154
Oct. 26, 2023 (JP) 2023-184122
Mar. 11, 2024 (JP) 2024-037339

(51) Int. Cl. G03G 5/147; G03G 21/18

(52) U.S. Cl. CPC G03G 5/14734; G03G 5/14795; G03G 21/1814; G03G 21/1857

(57) ABSTRACT

Provided is a process cartridge capable of suppressing the occurrence of a banding image that is detachably attachable onto a main body of an electrophotographic apparatus. A developing roller and a toner supply roller are configured to be rotated so that R represented by the following formula (E1) satisfies 1.2≤R≤1.5 and are configured so that a movement direction of a surface of the developing roller is opposite to a movement direction of a surface of the toner supply roller at a contact position with respect to the toner supply roller: R=V_{RS}/V_{D} Formula (E1) (in the formula (E1), V_{RS} represents an absolute value of a peripheral speed [m/s] of the toner supply roller, and V_{D} represents an absolute value of a peripheral speed [m/s] of the developing roller). An electrophotographic photosensitive member includes a surface layer containing a polyarylate resin including a structural unit represented by the following formula (A1).

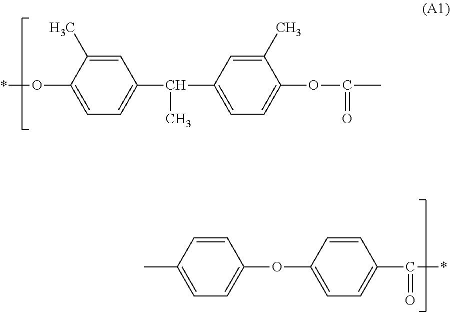

### BACKGROUND

### Field of the Disclosure

The present disclosure relates to a process cartridge and an electrophotographic apparatus each including an electrophotographic photosensitive member.

### Description of the Related Art

In recent years, measures for extending the service life of electrophotographic apparatus have been strengthened. However, in an electrophotographic process, the extension of the service life of the apparatus is liable to cause various adverse effects, and various efforts have been made to counter various adverse effects associated with the extension of the service life.

One of the above-mentioned adverse effects is a problem in that the surface states of a toner supply roller, a developing roller, and an electrophotographic photosensitive member (hereinafter sometimes simply referred to as “photosensitive member”) to be mounted on the electrophotographic apparatus are changed due to repeated use, and the abutment state between the toner supply roller and the developing roller or between the developing roller and the photosensitive member becomes unstable. When the abutment state becomes unstable, an image defect called a “banding image” occurs.

In order to solve those adverse effects, the configuration of the developing roller and the toner supply roller that supplies toner to the developing roller has been devised.

In Japanese Patent Application Laid-Open No. H11-249410, there is a description of a developing device in which a toner supply roller has a hollow in an entirety or a part of a central axis line portion. When the toner supply roller has a hollow, the toner supply roller can be easily deformed in response to a stress applied to a peripheral surface thereof. Thus, the banding caused by an increase in drive torque of a developing roller due to the high abutment pressure between the developing roller and a developer supply roller can be suppressed.

In Japanese Patent Application Laid-Open No. 2020-79902, there is a description of an image forming apparatus in which the water washing migration amount of inorganic silicon fine particles on the surfaces of toner particles is 0.20 mass % or less, the range of a peripheral speed ratio, which is the ratio of the peripheral speed of a developer carrying member to the peripheral speed of an image bearing member, is from 120% to 300%, and the dark portion potential Vd of the image bearing member and the bias Vb applied to a regulating member that regulates a developer satisfy the relationship of Vd<Vb. The above mentioned configuration controls the liberation of an external additive to suppress image smearing. The adhesion of a discharge product and moisture in the atmosphere to a photosensitive member serving as the image bearing member, caused by the image smearing, increases the tackiness of the surface of the photosensitive member and changes the surface state of the photosensitive member.

According to the investigations made by the inventors, in the technologies described in Japanese Patent Application Laid-Open Nos. H11-249410 and 2020-79902, the measures against an increase in dynamic friction coefficient between the developing roller and the photosensitive member in association with a change in surface of the developing roller are insufficient.

In particular, when a configuration in which the rotation directions of the developing roller and the toner supply roller are opposite to each other in a rubbing portion therebetween (hereinafter referred to as “counter configuration”) is adopted, and a ratio (R) between the absolute value of the peripheral speed of the toner supply roller and the absolute value of the peripheral speed of the developing roller is set to a value larger than 1, as described below in detail, the influence of friction on the developing roller received from the toner supply roller is significant. In the case where the friction between the developing roller and the toner supply roller causes a portion of the developing roller in which the surface state is unstable, such as a decrease in viscoelasticity, when the portion is brought into abutment against the surface of the photosensitive member, the dynamic friction coefficient between the developing roller and the photosensitive member is increased. There is a problem in that this increase in dynamic friction coefficient causes an image defect such as streak-like unevenness. An electrophotographic image in which streak-like unevenness occurs is hereinafter sometimes referred to as “banding image”.

### SUMMARY

Thus, an object of the present disclosure is to provide a process cartridge and an electrophotographic apparatus capable of suppressing the occurrence of a banding image caused by an increase in dynamic friction coefficient between the surface of a developing roller and the surface of a photosensitive member and forming an electrophotographic image of high quality.

The above-mentioned object is achieved by the present disclosure to be described below. That is, a process cartridge according to the present disclosure is a process cartridge including: a process cartridge being detachably attachable onto a main body of an electrophotographic apparatus, the process cartridge including: an electrophotographic photosensitive member; a developing roller configured to develop an electrostatic latent image formed on a surface of the electrophotographic photosensitive member; and a toner supply roller arranged in contact with the developing roller and configured to supply toner to the developing roller, wherein the developing roller and the toner supply roller are configured so that a movement direction of a surface of the developing roller and a movement direction of a surface of the toner supply roller at the time of operation are opposite to each other at a contact position of the developing roller and the toner supply roller, and the developing roller and the toner supply roller are configured to be rotated so that R represented by the following formula (E1) satisfies 1.2≤R≤1.5:

$$R = {V}_{RS} / {V}_{D} \qquad ( E1 )$$

in the formula (E1), V_{RS} represents an absolute value of a peripheral speed [m/s] of the toner supply roller, and V_{D} represents an absolute value of a peripheral speed [m/s] of the developing roller, wherein the surface of the developing roller is a surface of an elastic layer, wherein the toner supply roller includes a shaft body and a resin layer formed on an outer peripheral surface of the shaft body, and wherein the electrophotographic photosensitive member includes a surface layer containing a polyarylate resin including a structural unit represented by the following formula (A1).

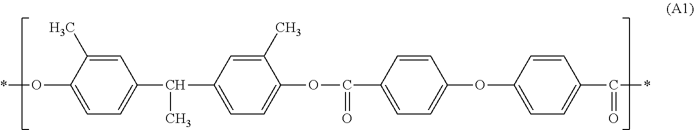

Further features of the present disclosure will become apparent from the following description of exemplary embodiments with reference to the attached drawings.

### BRIEF DESCRIPTION OF THE DRAWINGS

FIG. 1 is a structural unit of a polyarylate resin of the present disclosure.

FIG. 2 is a schematic sectional view of a process cartridge according to Examples to which the present disclosure is applicable.

FIG. 3 is a schematic view of a configuration in which a driving force is input to an axial end portion of a toner supply roller to rotate the toner supply roller, and the rotation driving force thereof is transmitted to a developing roller according to Examples to which the present disclosure is applicable.

FIG. 4 is a schematic view of a configuration in which a driving force is input to an axial end portion of a toner supply roller, the driving force thereof is transmitted to a developing roller to rotate the developing roller, and the rotation driving force thereof is transmitted to the toner supply roller according to Examples to which the present disclosure is applicable.

### DESCRIPTION OF THE EMBODIMENTS

The present disclosure is described below in detail by way of exemplary embodiments.

The present disclosure is directed to a process cartridge being detachably attachable onto a main body of an electrophotographic apparatus, the process cartridge including: an electrophotographic photosensitive member; a developing roller configured to develop an electrostatic latent image formed on a surface of the electrophotographic photosensitive member; and a toner supply roller arranged in contact with the developing roller and configured to supply toner to the developing roller, wherein the developing roller and the toner supply roller are configured so that a movement direction of a surface of the developing roller and a movement direction of a surface of the toner supply roller at the time of operation are opposite to each other at a contact position of the developing roller and the toner supply roller, and the developing roller and the toner supply roller are configured to be rotated so that R represented by the following formula (E1) satisfies 1.2≤R≤1.5:

$$R = {V}_{RS} / {V}_{D} \qquad ( E1 )$$

in the formula (E1), V_{RS} represents an absolute value of a peripheral speed [m/s] of the toner supply roller, and V_{D} represents an absolute value of a peripheral speed [m/s] of the developing roller, wherein the surface of the developing roller is a surface of an elastic layer, wherein the toner supply roller includes a shaft body and a resin layer formed on an outer peripheral surface of the shaft body, and wherein the electrophotographic photosensitive member includes a surface layer containing a polyarylate resin including a structural unit represented by the following formula (A1).

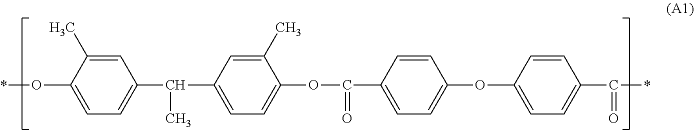

According to the investigations made by the inventors, in the related art, the measures against an increase in dynamic friction coefficient between the developing roller and the photosensitive member in association with a change in surface of the developing roller are insufficient.

In view of the foregoing, the inventors have found that the above-mentioned problem can be solved when a combination of the configuration of the developing roller and the toner supply roller and the material for the surface of the photosensitive member is optimized; the developing roller and the toner supply roller are configured to be rotated so that R represented by the following formula (E1) satisfies 1.2≤R≤1.5, and are configured so that the movement direction of the surface of the developing roller is opposite to the movement direction of the surface of the toner supply roller at a contact position with respect to the toner supply roller; the surface of the developing roller has an elastic layer; the toner supply roller includes a metal core and a resin layer on the periphery of the metal core; and the photosensitive member includes a surface layer containing a polyarylate resin including a structural unit represented by the following formula (A1):

$$R = {V}_{RS} / {V}_{D} \qquad ( E1 )$$

in the formula (E1), V_{RS} represents an absolute value of a peripheral speed [m/s] of the toner supply roller, and V_{D} represents an absolute value of a peripheral speed [m/s] of the developing roller.

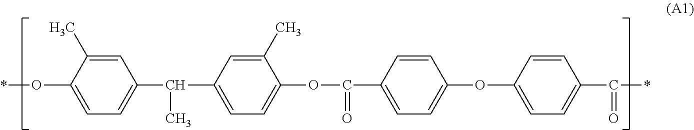

The inventors have conceived the following as a mechanism capable of solving the above-mentioned problem with such configuration.

When the toner supply roller has a counter configuration with respect to the developing roller, and the R is set to a value larger than 1, the toner supply amount from the toner supply roller to the developing roller becomes stable. Meanwhile, in the above-mentioned configuration, the influence of friction on the developing roller received from the toner supply roller is significant, and the surface of the developing roller is liable to be increased in temperature due to the friction heat with respect to the toner supply roller. In particular, when the surface of the developing roller has an elastic layer, the surface of the developing roller is pulled by abutment against the toner supply roller, with the result that the surface of the developing roller temporarily expands. When the developing roller passes by the abutment point with respect to the toner supply roller, the surface of the developing roller attempts to shrink due to the entropic elasticity because the developing roller itself has been increased in temperature. Simultaneously with this, a portion of the surface of the developing roller in which viscoelasticity is decreased occurs when the developing roller receives the friction heat with respect to the toner supply roller.

When the portion of the surface of the developing roller which has become unstable due to an increase in temperature as described above is brought into abutment against the photosensitive member, the friction state of the developing roller and the photosensitive member is fluctuated, and the dynamic friction coefficient between the developing roller and the photosensitive member is increased, with the result that an image defect such as banding occurs.

In view of the foregoing, the inventors have conceived incorporating a photosensitive member including a surface layer containing a polyarylate resin including a structural unit represented by the following formula (A1).

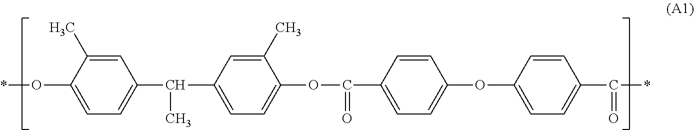

In the above-mentioned polyarylate resin, an ester moiety having an oxygen atom with high electronegativity present in the formula (A1) has polarization, and hence the resin is charged with δ−. Meanwhile, two methyl groups of benzene rings each have an electron-donating property, and hence the resin is charged with δ+. Meanwhile, the polyarylate resin contains an ether bond, and hence can be rotated with the ether bond as a starting point. Thus, in addition to the effect of the above-mentioned electrostatic attractive force, the rotation with the ether bond as a starting point allows sites on which the electrostatic attractive force acts to move freely to some extent and attract each other, and hence polymer chains are firmly bonded to each other. Accordingly, the fluctuation of the polyarylate resin is slow with respect to an external force such as heat.

Through incorporation of a photosensitive member including a surface layer containing the above-mentioned polyarylate resin, even when a portion of the developing roller in which the surface state is unstable is brought into abutment against the photosensitive member, the influence is less than that on the surface layer of a conventional photosensitive member, and as a result, an increase in dynamic friction coefficient between the developing roller and the photosensitive member can be suppressed.

As described in the above-mentioned mechanism, the effects of the present disclosure can be achieved when the configuration of the developing roller and the toner supply roller and the material for the surface of the photosensitive member exhibit synergistic effects on each other in the process cartridge of the present disclosure.

The configuration of the photosensitive member according to one aspect of the present disclosure is described in detail below.

### [Electrophotographic Photosensitive Member]

The photosensitive member of the present disclosure is characterized by including a surface layer.

A method of producing the photosensitive member of the present disclosure is, for example, a method involving: preparing coating liquids for the respective layers to be described later; applying the liquids in a desired order of the layers; and drying the liquids. In this case, examples of the method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

The respective layers are described below.

### <Support>

In the present disclosure, the photosensitive member includes a support. In the present disclosure, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. An aluminum support using aluminum out of those metals is preferred.

In addition, electroconductivity may be imparted to the resin or the glass through treatment involving, for example, mixing or coating the resin or the glass with an electroconductive material.

### <Electroconductive Layer>

In the photosensitive member of the present disclosure, an electroconductive layer may be arranged on the support. The arrangement of the electroconductive layer can conceal a flaw and unevenness on the surface of the support, and can control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles. In particular, titanium oxide, tin oxide, or zinc oxide is more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, the electroconductive particles may each have a laminated configuration including a core particle and a covering layer covering the core particle. A material for the core particle is, for example, titanium oxide, barium sulfate, or zinc oxide. A material for the covering layer is, for example, a metal oxide such as tin oxide.

In addition, when the metal oxide is used as the electroconductive particles, the volume-average particle diameter of the particles is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a concealing agent, such as a silicone oil, resin particles, or titanium oxide.

The average thickness of the electroconductive layer is preferably 1 μm or more and 50 μm or less, particularly preferably 3 μm or more and 40 μm or less.

The electroconductive layer may be formed by: preparing a coating liquid for an electroconductive layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent. A dispersion method for the dispersion of the electroconductive particles in the coating liquid for an electroconductive layer is, for example, a method including using a paint shaker, a sand mill, a ball mill, or a liquid collision-type high-speed dispersing machine.

### <Undercoat Layer>

In the photosensitive member of the present disclosure, an undercoat layer may be arranged on the support or the electroconductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having the polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron-transporting material, a metal oxide, a metal, an electroconductive polymer, and the like for the purpose of improving electric characteristics. Of those, an electron-transporting material and a metal oxide are preferably used.

Examples of the electron-transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting material having a polymerizable functional group may be used as the electron-transporting material and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The average thickness of the undercoat layer is preferably 0.1 μm or more and 50 μm or less, more preferably 0.2 μm or more and 40 μm or less, particularly preferably 0.3 μm or more and 30 μm or less.

The undercoat layer may be formed by: preparing a coating liquid for an undercoat layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, an ester-based solvent, and an aromatic hydrocarbon-based solvent.

### <Photosensitive Layer>

The photosensitive layer of the photosensitive member of the present disclosure is mainly classified into (1) a laminate type photosensitive layer and (2) a monolayer type photosensitive layer. (1) The laminate type photosensitive layer includes a charge-generating layer containing a charge-generating material and a charge-transporting layer containing a charge-transporting material. (2) The monolayer type photosensitive layer includes a photosensitive layer containing both of the charge-generating material and the charge-transporting material.

### (1) Laminate Type Photosensitive Layer

The laminate type photosensitive layer includes the charge-generating layer and the charge-transporting layer.

### (1-1) Charge-Generating Layer

The charge-generating layer preferably contains the charge-generating material and a resin.

Examples of the charge-generating material include an azo pigment, a perylene pigment, a polycyclic quinone pigment, an indigo pigment, and a phthalocyanine pigment. Of those, an azo pigment and a phthalocyanine pigment are preferred. Of the phthalocyanine pigments, an oxytitanium phthalocyanine pigment, a chlorogallium phthalocyanine pigment, and a hydroxygallium phthalocyanine pigment are preferred.

The content of the charge-generating material in the charge-generating layer is preferably 40 mass % or more and 85 mass % or less, more preferably 60 mass % or more and 80 mass % or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The average thickness of the charge-generating layer is preferably 0.1 μm or more and 1 μm or less, more preferably 0.15 μm or more and 0.4 μm or less.

The charge-generating layer may be formed by: preparing a coating liquid for a charge-generating layer containing the above-mentioned respective materials and a solvent; forming a coating film of the coating liquid; and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

### (1-2) Charge-Transporting Layer

The charge-transporting layer preferably contains the charge-transporting material and a resin.

Examples of the charge-transporting material include a polycyclic aromatic compound, a heterocyclic compound, a hydrazone compound, a styryl compound, an enamine compound, a benzidine compound, a triarylamine compound, and a resin having a group derived from any of those materials. Of those, a triarylamine compound and a benzidine compound are preferred.

The content of the charge-transporting material in the charge-transporting layer is preferably 25 mass % or more and 70 mass % or less, more preferably 30 mass % or more and 55 mass % or less with respect to the total mass of the charge-transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting material and the resin is preferably 4:10 to 20:10, more preferably 5:10 to 12:10.

In addition, the charge-transporting layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The average thickness of the charge-transporting layer is preferably 5 μm or more and 50 μm or less, more preferably 8 μm or more and 40 μm or less, particularly preferably 10 μm or more and 30 μm or less.

The charge-transporting layer may be formed by: preparing a coating liquid for a charge-transporting layer containing the above-mentioned respective materials and a solvent; forming a coating film of the coating liquid; and drying the coating film. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

### (2) Monolayer Type Photosensitive Layer

The monolayer type photosensitive layer may be formed by: preparing a coating liquid for a photosensitive layer containing the charge-generating material, the charge-transporting material, a resin, and a solvent; forming a coating film of the coating liquid; and drying the coating film. Examples of the charge-generating material, the charge-transporting material, and the resin are the same as those of the materials in the above-mentioned section “(1) Laminate Type Photosensitive Layer.”

### <Protective Layer>

In the present disclosure, a protective layer may be arranged on the photosensitive layer. The arrangement of the protective layer can improve durability.

The protective layer preferably contains electroconductive particles and/or a charge-transporting material, and a resin.

Examples of the electroconductive particles include particles of metal oxides, such as titanium oxide, zinc oxide, tin oxide, and indium oxide.

Examples of the charge-transporting material include a polycyclic aromatic compound, a heterocyclic compound, a hydrazone compound, a styryl compound, an enamine compound, a benzidine compound, a triarylamine compound, and a resin having a group derived from any of those materials. Of those, a triarylamine compound and a benzidine compound are preferred.

Examples of the resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the protective layer may be formed as a cured film by polymerizing a composition containing a monomer having a polymerizable functional group. A reaction at that time is, for example, a thermal polymerization reaction, a photopolymerization reaction, or a radiation polymerization reaction. Examples of the polymerizable functional group of the monomer having a polymerizable functional group include an acrylic group and a methacrylic group. A material having a charge-transporting ability may also be used as the monomer having a polymerizable functional group.

The protective layer may contain an additive, such as an antioxidant, a UV absorber, a plasticizer, a leveling agent, a slipperiness-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The average thickness of the protective layer is preferably 0.5 μm or more and 10 μm or less, more preferably 1 μm or more and 7 μm or less.

The protective layer may be formed by: preparing a coating liquid for a protective layer containing the above-mentioned respective materials and a solvent; forming a coating film of the coating liquid; and drying and/or curing the coating film. Examples of the solvent to be used in the coating liquid include an alcohol-based solvent, a ketone-based solvent, an ether-based solvent, a sulfoxide-based solvent, an ester-based solvent, and an aromatic hydrocarbon-based solvent.

### <Surface Layer>

In the photosensitive member according to the present disclosure, it is required that a surface layer contain a polyarylate resin including a structural unit represented by the following formula (A1).

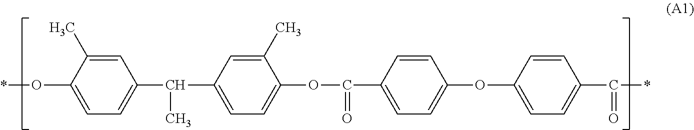

The surface layer as used herein is a portion in which the photosensitive member is brought into contact with toner and various members during an electrophotographic process. A protective layer, a charge-transporting layer, a monolayer type photosensitive layer, and a charge-generating layer may each serve as a surface layer, but the surface layer is preferably the charge-transporting layer from the viewpoint of satisfying both the cost and the basic electrical characteristics in the electrophotographic process.

The ¹H-nuclear magnetic resonance spectrum obtained by subjecting the component analysis of a polymer component recovered from the surface layer of the photosensitive member to ¹H-nuclear magnetic resonance analysis in deuterated chloroform has peaks at 2.21±0.02 ppm, 7.07±0.02 ppm, 7.11±0.02 ppm, and 7.13±0.02 ppm.

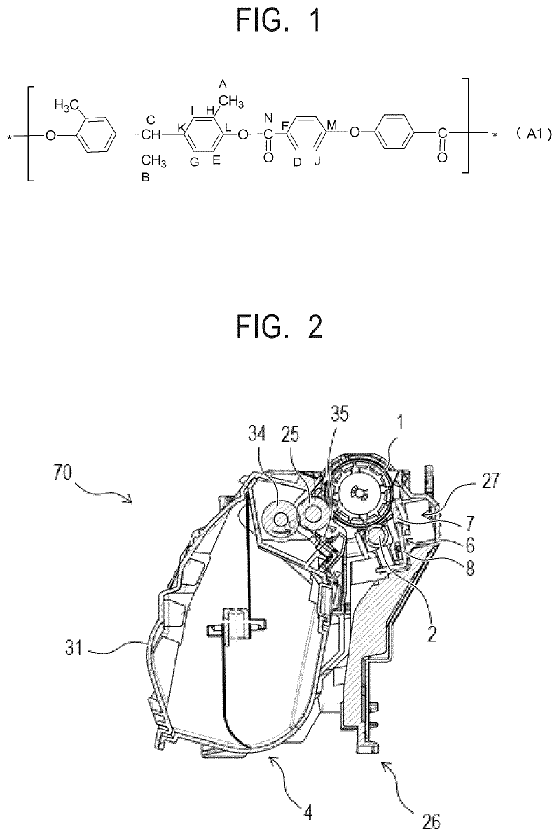

2.21±0.02 ppm corresponds to A in FIG. 1, 7.07±0.02 ppm corresponds to E in FIG. 1, 7.11±0.02 ppm corresponds to G in FIG. 1, and 7.13±0.02 ppm corresponds to I in FIG. 1, and from the positional relationship of the above-mentioned spectrum, it is indicated that a compound having the structure of the formula (A1) is contained.

A specific method is described below.

### Reprecipitation of Resin in Surface Layer of Photosensitive Member

Cutting of Photosensitive Member (Hereinafter Sometimes Simply Referred to as “Drum”) The drum is cut at a position 10 cm from an end portion of the drum in the generating line direction with a scroll saw.
Washing of Inner Surface of 10 cm Drum Having been Cut Out

An inner surface of the cylinder is wiped with lens-cleaning paper impregnated with chloroform.

### Elution of Surface Layer

3 cm of an end portion of the drum on a cut surface side is immersed in chloroform.

(About 60 cc of chloroform is loaded into a 100 mL beaker, and the immersion is performed at normal temperature for 5 minutes.)

### Concentration (Concentrated Solution Preparation)

The resultant is concentrated to 2 mL with a rotary evaporator, and the concentration is stopped.

### Reprecipitation

50 mL of a methanol/acetone mixed liquid (volume ratio: 1:1) is prepared, and the whole amount of the concentrated solution is dropped thereinto under stirring.

### Filtration

Suction filtration is performed with a Kiriyama funnel.

(Funnel: SU-40, paper filter: No. 5C-40, manufactured by Kiriyama Glass Co.)

### Drying

The residue on the paper filter is recovered with a spatula and subjected to vacuum drying (70° C., 1 hour).

### NMR Measurement

### Measurement Sample Preparation

20 mg of a sample is dissolved in 1 g of deuterated chloroform containing tetramethylsilane serving as a reference material, and the whole amount thereof is transferred to an NMR tube.
(Deuterated chloroform: manufactured by Sigma-Aldrich Japan G.K., chloroform-d, model number: 612200)
(NMR tube: manufactured by Norell, Inc., ST500-7, model number: S3010)

### NMR Measurement

Apparatus: AVANCE 500 manufactured by Bruker
Conditions: Proton NMR, automatic measurement by Icon-NMR
Number of scans: 32 Reference peak: The peak of a methyl group of tetramethylsilane is set as 0 ppm.
From the viewpoint of suppressing an increase in dynamic friction coefficient between the developing roller and the photosensitive member, the content of the polyarylate resin including the structural unit represented by the formula (A1) is preferably 45 mass % or more, more preferably 50 mass % or more, still more preferably 70 mass % or more with respect to the total mass of the surface layer.

In addition, from the viewpoint of the solubility in a solvent, the case including structural units to be a copolymer of the formula (A1) and the formula (A2) is desired, and the content mol % of the structural unit represented by the formula (A2) with respect to the structural unit represented by the formula (A1) is preferably 30 mol % or more and 70 mol % or less, more preferably 50 mol % or more and 70 mol % or less.

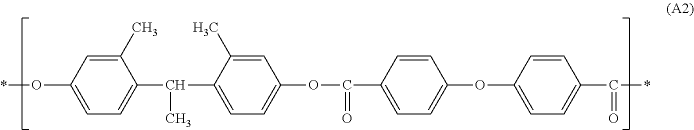

### [Process Cartridge and Electrophotographic Apparatus]

A process cartridge according to the present disclosure is a process cartridge being detachably attachable onto a main body of an electrophotographic apparatus, and is characterized by including: the electrophotographic photosensitive member described in the foregoing; a developing roller; and a toner supply roller. Here, the developing roller is configured to develop an electrostatic latent image formed on the surface of the photosensitive member, and the toner supply roller is arranged in contact with the developing roller and is configured to supply toner to the developing roller.

In addition, the electrophotographic apparatus according to the present disclosure is characterized by including the above-mentioned process cartridge.

In FIG. 2, there is illustrated an example of a main cross-section of a process cartridge 70 including a photosensitive member, a developing roller, and a toner supply roller.

The process cartridge 70 includes a photosensitive unit 26 and a developing unit 4. The photosensitive unit 26 includes a photosensitive drum 1, a charging roller 2, and a cleaning member 6. The developing unit 4 includes a developing roller 25 and a toner supply roller 34.

The charging roller 2 and the cleaning member 6 described above are arranged on the periphery of the photosensitive drum 1. The cleaning member 6 is formed of an elastic member 7 made of a rubber blade and a cleaning support member 8. The distal end portion of the elastic member 7 is arranged in abutment against the photosensitive drum 1 in a counter direction with respect to the rotation direction thereof. The toner removed from the surface of the photosensitive drum 1 by the cleaning member 6 falls into a removal toner chamber 27.

The photosensitive drum 1 is rotationally driven in accordance with an image forming operation by transmitting the driving force of a main body drive motor (not shown), which is a drive source, to the photosensitive unit 26.

The charging roller 2 is rotatably mounted on the photosensitive unit 26 through intermediation of a charging roller bearing, and is pressurized toward the photosensitive drum 1 by a charging roller-pressurizing member to be brought into abutment against the photosensitive drum 1, thereby being rotated following the rotation of the photosensitive drum 1.

The developing unit 4 includes the developing roller 25 that is rotated in contact with the photosensitive drum 1 and a developing frame 31 that supports the developing roller 25. The toner supply roller 34 that is rotated in a direction of the arrow C in contact with the developing roller 25 and a developing blade 35 for regulating a toner layer on the developing roller 25 are each arranged on the periphery of the developing roller 25.

The developing roller 25 and the photosensitive drum 1 are each rotated so that the surfaces thereof move in the same direction in an opposed (contact) portion. Toner negatively charged by frictional charging against a predetermined DC bias applied to the developing roller 25 is transferred only to a light portion potential part due to the potential difference in a developing portion that is brought into contact with the photosensitive drum 1, to thereby visualize an electrostatic latent image.

The developing blade 35 is arranged below the developing roller 25 and is in counter abutment against the developing roller 25, to thereby regulate the coat amount of toner supplied by the toner supply roller 34 and impart an electric charge to the toner. In Examples described later, the developing blade is formed of a plate member having flexibility and a developing blade support that fixes the plate member. In addition, the developing blade 35 is formed of an elastic plate made of stainless steel (SUS) or the like. The toner is frictionally charged by sliding between the developing blade 35 and the developing roller 25 to be given an electric charge and is simultaneously regulated for layer thickness. In addition, a predetermined voltage is applied to the developing blade 35 from a blade bias power supply (not shown) to stabilize the toner coat.

The toner supply roller 34 is in abutment against the developing roller 25 with a nip portion N, and in the present disclosure, it is required that the toner supply roller 34 and the developing roller 25 be rotated so that the movement direction of the toner supply roller 34 in the nip portion N and the movement direction of the developing roller 25 in the nip portion N are opposite to each other (counter configuration). That is, the movement direction of the surface of the developing roller 25 is set to be opposite to the movement direction of the surface of the toner supply roller 34 at a contact position with the toner supply roller 34. The toner supply roller 34 and the developing roller 25 are in contact with each other with a predetermined penetration amount, that is, a recessed amount ΔE of a recessed shape in the toner supply roller 34 formed by the developing roller 25. It is required that the toner supply roller 34 and the developing roller 25 be rotated with the following peripheral speed difference in opposite directions in the nip portion N. That is, the developing roller 25 and the toner supply roller 34 are configured to be rotated so that R represented by the following formula (E1) satisfies 1.2≤R≤1.5.

R=V_{RS}/V_{D} Formula (E1)

in the formula (E1), V_{RS} represents an absolute value of a peripheral speed [m/s] of the toner supply roller 34, and V_{D} represents an absolute value of a peripheral speed [m/s] of the developing roller 25.

Through this operation, toner supply to the developing roller 25 is performed while the residual toner on the developing roller 25 is recovered. In this case, the recovery amount of the residual toner on the developing roller 25 and the toner supply amount to the developing roller 25 can be adjusted by adjusting the potential difference between the toner supply roller 34 and the developing roller 25.

The toner supply roller 34 includes an electroconductive support and a foamed layer supported by the electroconductive support. Specifically, there are arranged a metal core electrode having an outer diameter of φ5 (mm) serving as the electroconductive support and a urethane foamed layer formed around the metal core electrode, the urethane foamed layer serving as the foamed layer formed of an open-cell foam (open cell) in which air bubbles are connected to each other, and the toner supply roller 34 is rotated in the direction of the arrow C in the figure. A large amount of toner is allowed to penetrate into the toner supply roller 34 by forming the urethane of the surface layer into an open-cell foam. In Examples described later, the resistance of the toner supply roller 34 is 1×10⁹Ω.

In Examples described later, the penetration amount of the toner supply roller 34 into the developing roller 25, that is, the recessed amount ΔE of the recessed shape in the toner supply roller 34 formed by the developing roller 25 was set to 1.0 mm. A method of measuring the resistance of the toner supply roller 34 is described below. The toner supply roller 34 is brought into abutment against an aluminum sleeve having a diameter of 30 mm so that the penetration amount described later is 1.5 mm. The toner supply roller 34 is rotated following the aluminum sleeve at 30 rpm by rotating the aluminum sleeve.

Next, a DC voltage of −50V is applied to the developing roller 25. In this case, a resistor of 10 kΩ is arranged on the ground side and the voltage at each end of the resistor is measured to calculate a current, to thereby calculate the resistance of the toner supply roller 34. In Examples described later, the surface cell diameter of the toner supply roller 34 was set to from 50 μm to 1,000 μm.

Here, the cell diameter refers to the average diameter of foamed cells in an arbitrary cross-section. The average diameter is obtained by first measuring the area of the largest foamed cell from an enlarged image of the arbitrary cross-section, converting the area into the diameter equivalent to a perfect circle to provide a maximum cell diameter, then removing the foamed cells each having a cell diameter equal to or less than ½ of the maximum cell diameter as noise, and converting the remaining individual cell areas into individual cell diameters in the same manner to provide an average thereof.

The toner supplied from the toner supply roller 34 to the surface of the developing roller 25 is frictionally charged by sliding between the developing blade 35 and the developing roller 25 to be given an electric charge and is simultaneously regulated for layer thickness. After that, the toner is conveyed to the abutment portion (developing portion) between the photosensitive drum 1 and the developing roller 25 and is transferred only to the light portion potential part. The residual toner remaining on the surface of the developing roller 25 is returned into a developing container again and is recovered from the surface of the developing roller 25 by the toner supply roller 34 to be stored in the toner supply roller 34.

The configuration for driving the developing roller 25 and the toner supply roller 34 preferably includes a driving force-receiving portion, a first driving force-transmitting portion, and a second driving force-transmitting portion. Here, the driving force-receiving portion is configured to receive a driving force for driving the toner supply roller 34. The first driving force-transmitting portion is configured to transmit the driving force received by the driving force-receiving portion to the toner supply roller 34. In addition, the second driving force-transmitting portion is configured to transmit the driving force generated by drive of the toner supply roller 34 to the developing roller 25. When the rotational drive of the developing roller 25 is indirectly performed through the second driving force-transmitting portion in response to the input of a driving force from outside, the second driving force-transmitting portion absorbs a sudden frictional force fluctuation and suppresses the instability of the coat amount of toner on the developing roller 25 (Reference Patent Literature: Japanese Patent Application Laid-Open No. 2014-134787). Specifically, the developing roller 25 is in contact with both the toner supply roller 34 and the photosensitive drum 1, and hence any sudden frictional force fluctuation that has occurred between the developing roller 25 and the photosensitive drum 1 influences the rotation of the toner supply roller 34 that is in contact with the developing roller 25. In addition, the coat amount of toner supplied onto the developing roller 25 by the toner supply roller 34 may become unstable. In the above-mentioned preferred configuration, the toner supply roller 34 is first driven by the input of a driving force from outside, and then the developing roller 25 is driven through the second driving force-transmitting portion. Thus, even when a sudden frictional force fluctuation occurs between the developing roller 25 and the photosensitive drum 1, the toner supply roller 34 is driven with a driving force from outside that is not influenced by the frictional force fluctuation, and the second driving force-transmitting portion absorbs the frictional force fluctuation. As a result, the toner supply roller 34 can stably supply toner to the developing roller 25. The above-mentioned configuration in which the sudden frictional force fluctuation suppresses the occurrence of instability of the coat amount of toner is suitable for suppressing banding at the time of repeated use in the present disclosure. The second driving force-transmitting portion may include a third driving force-transmitting portion, a fourth driving force-transmitting portion, and a fifth driving force-transmitting portion. Here, the third driving force-transmitting portion is arranged in an end portion of a shaft body of the toner supply roller 34 and is configured to transmit a driving force generated by drive of the toner supply roller 34 to the fourth driving force-transmitting portion. In addition, the fourth driving force-transmitting portion is configured to transmit the driving force to the fifth driving force-transmitting portion by being driven with the driving force received from the third driving force-transmitting portion. In addition, the fifth driving force-transmitting portion is arranged in an end portion of a mandrel of the developing roller 25 and is configured to drive the developing roller 25 by receiving the driving force from the fourth driving force-transmitting portion.

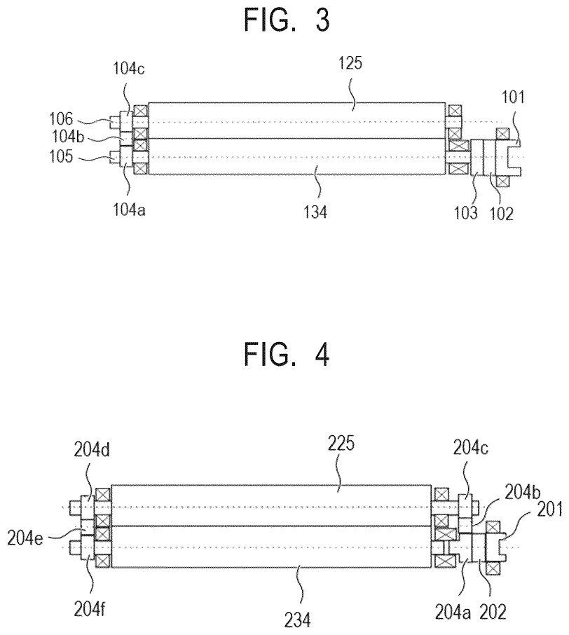

FIG. 3 is a schematic view of a specific example of a preferred configuration for driving the developing roller and the toner supply roller described above.

The driving force input to a coupling (driving force-receiving portion) 101 is transmitted to a driving force-transmitting member 103 through an intermediate 102 to drive the toner supply roller 134 rotationally. Here, the combination of the intermediate 102 and the driving force-transmitting member 103 corresponds to the first driving force-transmitting portion described above. The rotational driving force transmitted to the toner supply roller 134 is transmitted to a gear (third driving force-transmitting portion) 104a, a gear (fourth driving force-transmitting portion) 104b, and a gear (fifth driving force-transmitting portion) 104c in this order to drive the developing roller 125 rotationally. Here, the configuration formed of the combination of the gear 104a, the gear 104b, and the gear 104c corresponds to the second driving force-transmitting portion described above. That is, the gear 104a is arranged in an end portion of a shaft body 105 of the toner supply roller 134, and transmits the driving force generated by drive of the toner supply roller 134 to the gear 104b. Subsequently, the gear 104b is driven with the driving force received from the gear 104a to transmit the driving force to the gear 104c. The gear 104c is arranged in an end portion of a mandrel 106 of the developing roller 125, and receives the driving force from the gear 104b to drive the developing roller 125. As a result, the driving force generated by drive of the toner supply roller 134 is transmitted to the developing roller 125. In an example illustrated in FIG. 3, there is looseness in intermeshing portions between the gears 104a, 104b, and 104c, and hence the sudden frictional force fluctuation that has occurred between the developing roller 125 and the photosensitive drum can be absorbed. Then, the driving force transmitted from outside to the toner supply roller 134 through the coupling 101, the intermediate 102, and the driving force-transmitting member 103 is not influenced by such frictional force fluctuation, and hence the toner supply roller 134 is stably driven. As a result, a fluctuation in supply amount of toner from the toner supply roller 134 to the developing roller 125 can be suppressed.

The specific configuration of the second driving force-transmitting portion is not limited to the configuration formed of the combination of the gears 104a, 104b, and 104c illustrated in FIG. 3. The specific configuration of the second driving force-transmitting portion may be a configuration using any mechanism as long as the configuration is capable of transmitting the driving force generated by drive of the toner supply roller 134 to the developing roller 125.

In the preferred configuration for driving the developing roller 125 and the toner supply roller 134 described above, the above-mentioned R is required to satisfy 1.2≤R≤1.5. In order to achieve the foregoing, it is only required that the toner supply roller 134, the second driving force-transmitting portion, and the developing roller 125 be driven to be coupled. That is, when the radius of the developing roller 125 is represented by r_{D} [mm] and the radius of the toner supply roller 134 is represented by r_{RS} [mm], it is only required that each of the above-mentioned members be driven to be coupled so that λ represented by the following formula (E2) satisfies 1.2≤λ×r_{RS}/r_{D}≤1.5. Here, the λ represented by the formula (E2) represents the ratio of a rotational angular velocity with respect to the radius r_{D} of the developing roller 125 and the radius r_{RS} of the toner supply roller 134.

$$λ = {ω}_{RS} / {ω}_{D} \qquad ( E2 )$$

In the formula (E2), ω_{RS} represents the rotational angular velocity [rad/s] of the toner supply roller 134, and ω_{D} represents the rotational angular velocity [rad/s] of the developing roller 125.

As an example, in the specific configuration illustrated in FIG. 2, it is only required that the gear ratio of the three gears 104a, 104b, and 104c be set so that the X satisfies 1.2≤λ×r_{RS}/r_{D}≤1.5.

As an example, in the specific configuration illustrated in FIG. 3, it is only required that the gear ratio of the three gears 104a, 104b, and 104c be set so that the X satisfies 1.2≤λ×r_{RS}/r_{D}≤1.5.

In FIG. 4, there is illustrated another example of the configuration for driving the developing roller and the toner supply roller.

The driving force input to a coupling 201 is transmitted to a gear 204a through an intermediate 202 and is transmitted to a gear 204b and a gear 204c in this order to drive a developing roller 225 rotationally. The rotational drive force is transmitted to a gear 204d, a gear 204e, and a gear 204f in this order to drive a toner supply roller 234 rotationally.

In the present disclosure, from the viewpoint of suppressing an increase in dynamic friction coefficient between the developing roller and the photosensitive member caused by a change in surface of the developing roller, the above-mentioned R preferably satisfies 1.2≤R≤1.3.

The process cartridge according to the present disclosure may be used in, for example, a laser beam printer, an LED printer, a copying machine, a facsimile, and a multifunctional peripheral thereof.

### [Developing Roller]

In a developing roller used in the present disclosure, the surface of the developing roller is required to be the surface of an elastic layer. The developing roller is an elastic roller having a configuration in which an electroconductive elastic rubber layer having a predetermined volume resistance serving as an elastic layer is formed on the periphery of an electroconductive substrate, for example, a metal core made of a metal.

The configuration of the developing roller according to one aspect of the present disclosure is described below in detail.

### <Electroconductive Substrate>

A columnar or hollow cylindrical electroconductive mandrel may be used as an electroconductive substrate. The shape of the mandrel may be a columnar shape or a hollow cylindrical shape, and the mandrel may be formed of the following electroconductive material. That is, examples of the electroconductive material include: a metal or an alloy, such as aluminum, a copper alloy, or stainless steel; iron subjected to plating treatment with chromium or nickel; and a synthetic resin having electroconductivity. A known adhesive may be appropriately applied to the surface of the electroconductive substrate for the purpose of improving its adhesive property with, for example, the elastic layer on the outer periphery of the electroconductive substrate.

### <Elastic Layer>

An elastic layer may include a plurality of layers having different characteristics depending on the required function. The elastic layer is usually preferably formed of a molded article of a rubber material. Examples of the rubber material include an ethylene-propylene-diene copolymerized rubber (EPDM), an acrylonitrile-butadiene rubber (NBR), a chloroprene rubber (CR), a natural rubber (NR), an isoprene rubber (IR), a styrene-butadiene rubber (SBR), a fluororubber, a silicone rubber, an epichlorohydrin rubber, a hydrogenated product of NBR, and a urethane rubber. Those rubber materials may be used alone or in combination thereof.

In addition, the surface of the elastic layer may also be subjected to commonly known surface treatment, for example, UV treatment, electron beam treatment, or impregnation treatment in accordance with the required characteristics. From the viewpoint of suppressing a change in dynamic friction coefficient between the developing roller and the photosensitive member, the MD-1 hardness measured at a temperature of 23° C. for the outer surface of a developing member is preferably 200 or more and 550 or less, more preferably 370 or more and 550 or less.

Electroconductivity may be imparted to the elastic layer by blending an electroconductivity-imparting agent, such as an electronic electroconductive material or an ionic electroconductive material.

Examples of the electronic electroconductive material include: electroconductive carbons including carbon blacks, such as ketjen black EC and acetylene black; carbons for rubbers, such as super abrasion furnace (SAF), intermediate SAF (ISAF), high abrasion furnace (HAF), fast extruding furnace (FEF), general purpose furnace (GPF), semi-reinforcing furnace (SRF), fine thermal (FT), and medium thermal (MT); carbons for colors (inks) each subjected to oxidation treatment; and metals, such as copper, silver, and germanium, and metal oxides thereof. Of those, electroconductive carbon is preferred because the electroconductivity can be easily controlled with a small amount.

Examples of the ionic electroconductive material include: inorganic ionic electroconductive materials, such as sodium perchlorate, lithium perchlorate, calcium perchlorate, and lithium chloride; and organic ionic electroconductive materials, such as a modified aliphatic dimethylammonium ethosulfate and stearylammonium acetate.

Those electroconductivity-imparting agents are each appropriately blended in a required amount in accordance with the electroconductivity required in the elastic layer.

Various additives, such as particles, an electroconductive agent, a plasticizer, a filler, an extender, a crosslinking agent, a crosslinking accelerator, a vulcanization aid, a crosslinking aid, an acid acceptor, a curing inhibitor, an antioxidant, and an age inhibitor, may each be further incorporated into the elastic layer as required. Those optional components may each be blended in an amount in such a range that the features of the present disclosure are not impaired.

Examples of the crosslinking agent include sulfur-based crosslinking agents including sulfurs, such as powdered sulfur, oil-treated powdered sulfur, precipitated sulfur, colloidal sulfur, and dispersible sulfur, and organic sulfur-containing compounds, such as tetramethylthiuram disulfide and N,N-dithiobismorpholine. The blending proportion of the sulfur is preferably 0.5 part by mass or more and 2.0 parts by mass or less per 100 parts by mass of the total amount of the rubber material in consideration of impartment of satisfactory characteristics as the rubber. In addition, when the organic sulfur-containing compound is used as the crosslinking agent, the amount of sulfur in the molecule is preferably adjusted to the proportion within the above-mentioned range.

As the filler, for example, zinc oxide, silica, carbon black, talc, calcium carbonate, magnesium carbonate, and aluminum hydroxide may be used. The mechanical strength of a binder resin can be expected to be improved by blending those fillers. In addition, as described above, electronic electroconductivity may also be imparted to an electrophotographic member by using electroconductive carbon black that functions as an electronic electroconductive agent as the filler. The filler is appropriately blended in a required amount in accordance with the characteristics required for a molded article.

### [Toner Supply Roller]

The toner supply roller according to the present disclosure is required to include an electroconductive shaft body and a foamed layer on the shaft body.

The configuration of the toner supply roller according to one aspect of the present disclosure is described below in detail.

### <Shaft Body>

A shaft body functions as a support member of the toner supply roller and an electrode. The shaft body is formed of an electroconductive material, for example, a metal or an alloy, such as aluminum, a copper alloy, or stainless steel; iron subjected to plating treatment with chromium or nickel; or a synthetic resin having electroconductivity. The shaft body has a solid columnar shape or a hollow cylindrical shape.

### ≤Resin Layer>

The foamed layer preferably contains a polyurethane resin (crosslinked urethane resin) described later as a binder resin from the viewpoint of strength. The foamed layer preferably has voids that can store toner particles in the layer in order to supply the toner particles uniformly to the surface of a toner carrying member roller serving as the toner supply roller. Examples of the voids include a large number of through holes and non-through holes. In addition, another example of the voids may be a porous body in a state of bubbles connected to each other (open cell). An electroconductive layer containing a crosslinked urethane resin is preferably in an open-cell state having large voids. The characteristics, such as the average cell diameter on a surface, the number of cells, the airflow rate, and the density of an entire layer of the foamed layer having voids described above are important. Although the physical property values of the foamed layer are not particularly limited, it is preferred that the foamed layer have, for example, values within the following numerical value ranges.
Average cell diameter on surface: 100 μm or more and 500 μm or less;
Number of cells: 50 cells/inch or more and 300 cells/inch or less;
Airflow rate: 0.5 L/min or more and 3.0 L/min or less;
Density: 0.05 g/cm³ or more and 0.20 g/cm³ or less.

### <Polyurethane Resin>

A polyurethane resin is a reaction product of a polyol and a compound having an isocyanate group. Examples of the polyol that forms the crosslinked urethane resin of the toner supply roller of the present disclosure include a polyester polyol, a polyether polyol, an acrylic polyol, a polycarbonate polyol, and a polycaprolactone polyol. Of those, the polyether polyol is preferred because the crosslinked urethane resin has flexibility.

Examples of the polyether polyol include the following: polyethylene glycol, polypropylene glycol, poly-1,4-butanediol, poly-1,5-pentanediol, polyneopentyl glycol, poly-3-methyl-1,5-pentanediol, poly-1,6-hexanediol, poly-1,8-octanediol, and poly-1,9-nonanediol. Of those, from the viewpoint of suppressing an increase in hardness, polypropylene glycol, pol-yl,4-butanediol, poly-1,5-pentanediol, polyneopentyl glycol, poly-3-methyl-1,5-pentanediol, and poly-1,6-hexanediol are preferred. In addition, examples of the polyester polyol include the following: polyester polyols obtained by the condensation reaction of diol components, such as ethylene glycol, propylene glycol, 1,4-butanediol, 1,5-pentanediol, neopentyl glycol, 3-methyl-1,5-pentanediol, 1,6-hexanediol, 1,8-octanediol, and 1,9-nonanediol, or triol components such as trimethylolpropane with dicarboxylic acids, such as adipic acid, suberic acid, sebacic acid, phthalic anhydride, terephthalic acid, and hexahydroxyphthalic acid. Of those, from the viewpoint of suppressing an increase in hardness, the polyester polyols obtained by the condensation reaction of diol components, such as propylene glycol, 1,4-butanediol, 1,5-pentanediol, neopentyl glycol, 3-methyl-1,5-pentanediol, and 1,6-hexanediol, with dicarboxylic acids, such as adipic acid, suberic acid, and sebacic acid, are preferred.

In addition, examples of the polycaprolactone polyol include the following: poly-F-caprolactone and poly-γ-caprolactone.

In addition, examples of the polycarbonate polyol include the following: polycarbonate polyols obtained by the condensation reaction of diol components, such as ethylene glycol, propylene glycol, 1,4-butanediol, 1,5-pentanediol, neopentyl glycol, 3-methyl-1,5-pentanediol, 1,6-hexanediol, 1,8-octanediol, and 1,9-nonanediol, with dialkyl carbonates, such as phosgene and dimethyl carbonate, or cyclic carbonates such as ethylene carbonate. Of those, from the viewpoint of suppressing an increase in hardness, the polycarbonate polyols obtained by the condensation reaction of diol components, such as neopentyl glycol, 3-methyl-1,5-pentanediol, 1,5-pentanediol, 1,6-hexanediol, and 1,8-octanediol, with dialkyl carbonates such as dimethyl carbonate. Those polyol components may be formed into prepolymers that are subjected to chain extension in advance with isocyanate compounds, such as 2,4-tolylene diisocyanate (TDI), 4,4′-diphenylmethane diisocyanate (MDI), and isophorone diisocyanate (IPDI), as required.

### <Isocyanate Compound>

An isocyanate compound is not particularly limited, and as the isocyanate compound, there may be used aliphatic polyisocyanates, such as ethylene diisocyanate and 1,6-hexamethylene diisocyanate (HDI); alicyclic polyisocyanates, such as isophorone diisocyanate (IPDI), cyclohexane-1,3-diisocyanate, and cyclohexane-1,4-diisocyanate; aromatic isocyanates, such as 2,4-tolylene diisocyanate, 2,6-tolylene diisocyanate (TDI), 4,4′-diphenylmethane diisocyanate (MDI), polymeric diphenylmethane diisocyanate, xylylene diisocyanate, and naphthalene diisocyanate; and copolymers, isocyanurate products, TMP adduct products, biuret products, and blocked products thereof. Of those, aromatic isocyanates, such as tolylene diisocyanate and diphenylmethane diisocyanate, are preferred. It is preferred that the polyol component and the isocyanate compound be mixed so that the ratio (molar ratio) of an isocyanate group in the isocyanate compound falls within the range of 1.0 or more and 2.0 or less with respect to 1.0 of hydroxyl groups in the polyol component. When the mixing ratio falls within the above-mentioned range, residual unreacted components can be suppressed.

### <Crosslinking Agent>

As a component forming the polyurethane resin of the present disclosure, a crosslinking agent is preferably incorporated. As a crosslinking structure, trifunctional or higher isocyanates and trifunctional or higher polyols can function as crosslinking agents to form a crosslinking structure. In addition, separately from the foregoing, known crosslinking agents that are optimum for the urethane resin may also be used. Examples thereof include an amine-based crosslinking agent such as ethylenediamine and an imide-based crosslinking agent such as a carbodiimide.

### <Other Components in Resin Layer>

The resin layer may contain an electroconductive filler to the extent that the effects of the present disclosure are not impaired, as required. The resin layer preferably contains an electronic electroconductive filler.

As the electroconductive filler, carbon black and an electroconductive metal, such as aluminum or copper, may be used. Of those, carbon black is particularly preferably used because carbon black is relatively easily available and has a high electroconductivity-imparting property and a high reinforcing property. In the foamed layer, a catalyst, a foaming agent, a foam regulator, and other aids may be used, as required.

The catalyst is not particularly limited and may be appropriately selected to be used from various catalysts known as the related art. For example, an amine-based catalyst (e.g., triethylenediamine, bis(dimethylaminoethyl)ether, N,N,N′,N′-tetramethylhexanediamine, 1,8-diazabicyclo(5.4.0)undecene-7, 1,5-diazabicyclo(4.3.0)nonene-5, 1,2-dimethylimidazole, N-ethylmorpholine, or N-methylmorpholine), an organometallic catalyst (e.g., tin octylate, tin oleate, dibutyltin dilaurate, dibutyltin diacetate, titanium tetra-i-propoxide, titanium tetra-n-butoxide, or tetrakis(2-ethylhexyloxy)titanium), or an acid salt catalyst obtained by reducing the initial activity of the amine-based catalyst and the organometallic catalyst (e.g., a carboxylic acid salt, a formic acid salt, an octylic acid salt, or a boric acid salt) may be used. The catalysts may be used alone or in combination thereof.

The foaming agent is not particularly limited and may be appropriately selected to be used from various foaming agents known as the related art. In particular, water is suitably used as a foaming agent because water reacts with polyisocyanate to generate carbon dioxide. In addition, even when another foaming agent and water are used together, the main purpose of the present disclosure is not impaired.

The foam regulator is not particularly limited and may be appropriately selected to be used from various foam regulators known as the related art. As other aids, as required, a crosslinking aid, a flame retardant, a colorant, a UV absorber, an antioxidant, and the like may be used to the extent that the effects of the present disclosure are not impaired.

The toner supply roller includes an electroconductive shaft body and a resin layer serving as a foamed layer on the shaft body.

According to the present disclosure, there can be provided a process cartridge and an electrophotographic apparatus capable of suppressing the occurrence of a banding image caused by an increase in dynamic friction coefficient between the developing roller and the photosensitive member.

### EXAMPLES

The present disclosure is described below in more detail by way of Examples and Comparative Examples. The present disclosure is not limited in any way by the following Examples within a scope not departing from the gist of the present disclosure. In the following description of Examples, the term “part(s)” is by mass unless otherwise specified.

### <Production of Electrophotographic Photosensitive Member>

### <Production of Photosensitive Member 1>

### (Support)

A cylinder formed of a cut aluminum alloy having an outer diameter of 24 mm, a length of 257 mm, and a thickness of 0.75 mm was used as a support.

### (Formation of Undercoat Layer)

100 Parts of rutile-type titanium oxide particles (product name: MT-600B, average primary particle diameter: 50 nm, manufactured by Tayca Corporation) were stirred and mixed with 500 parts of toluene, and 5.0 parts of vinyltrimethoxysilane (product name: KBM-1003, manufactured by Shin-Etsu Chemical Co., Ltd.) was added to the mixture, followed by stirring for 8 hours. After that, toluene was evaporated by distillation under reduced pressure, and the residue was dried at 120° C. for 3 hours. Thus, rutile-type titanium oxide particles whose surfaces had already been treated with vinyltrimethoxysilane were obtained.

Subsequently, the following materials were prepared.
The above-mentioned rutile-type titanium oxide particles whose surfaces had already been treated with vinyltrimethoxysilane: 18 parts
N-Methoxymethylated nylon (product name: TORESIN EF-30T, manufactured by Nagase ChemteX Corporation): 4.5 parts
Copolymerized nylon resin (product name: AMILAN (trademark) CM8000, manufactured by Toray Industries, Inc.): 1.5 parts

Those materials were added to a mixed solvent of 90 parts of methanol and 60 parts of 1-butanol to prepare a dispersion liquid. The dispersion liquid was subjected to dispersion treatment in a vertical sand mill through use of glass beads each having a diameter of 1.0 mm for 5 hours to prepare a coating liquid for an undercoat layer.

The coating liquid for an undercoat layer was applied onto the above-mentioned support by dip coating to form a coating film, and the coating film was dried at 100° C. for 10 minutes to form an undercoat layer having a thickness of 2.00 μm.

### (Formation of Charge-Generating Layer)

10 Parts of a Y-type oxytitanium phthalocyanine crystal having a strong peak at a Bragg angle (2θ±0.2°) in CuKα characteristic X-ray diffraction of 27.3° was prepared as a charge-generating material. 10 Parts of the Y-type oxytitanium phthalocyanine crystal and 150 parts of 4-methoxy-4-methylpentanone-2 were loaded in a sand mill using glass beads each having a diameter of 1 mm, and were subjected to pulverization and dispersion treatment with a sand grind mill for 1.5 hours.

Next, 105 parts of a solution obtained by adding and dissolving 5 parts of a polyacetal resin (product name: S-LEC BX-1, manufactured by Sekisui Chemical Co., Ltd.) in 100 parts of 4-methoxy-4-methylpentanone-2 in advance was added, and the resultant mixture was subjected to dispersion treatment for 0.5 hour.

After that, 250 parts of 1,2-dimethoxyethane was added to the mixture to prepare a coating liquid for a charge-generating layer. A coating liquid for the charge-generating layer was applied onto the resultant undercoat layer by dip coating to form a coating film, and the coating film was dried at 100° C. for 10 minutes to form a charge-generating layer having a thickness of 0.15 μm.

The X-ray diffraction measurement was performed under the following conditions.

### [Powder X-ray Diffraction Measurement]

Measurement apparatus used: X-ray diffraction apparatus RINT-TTRII manufactured by Rigaku Denki Co., Ltd.
X-ray tube bulb: Cu
Tube voltage: 50 KV
Tube current: 300 mA
Scan method: 2θ/θ scan
Scan speed: 4.0°/min
Sampling interval: 0.020
Start angle (20): 5.0°
Stop angle (20): 40.0°
Attachment: standard sample holder
Filter: not used
Incident monochrometer: used
Counter monochrometer: not used
Divergent slit: open
Divergent longitudinal restriction slit: 10.00 mm
Scattering slit: open
Light receiving slit: open
Flat sheet monochrometer: used
Counter: scintillation counter

### (Formation of Surface Layer (Charge-Transporting Layer))

Next, the following materials were prepared.
Charge-transporting material represented by the following formula (CTM1): 69 parts
Antioxidant represented by P1: 7 parts
Polyarylate resin including the structural unit represented by the formula (A1): 100 parts

Those materials were dissolved in a mixed solvent of 23 parts of ortho-xylene, 23 parts of methyl benzoate, and 23 parts of dimethoxymethane to prepare a coating liquid for a surface layer. The coating liquid for a surface layer was applied onto the charge-generating layer by dip coating to form a coating film, and the coating film was dried at 125° C. for 30 minutes to form a surface layer having a thickness of 15 μm.

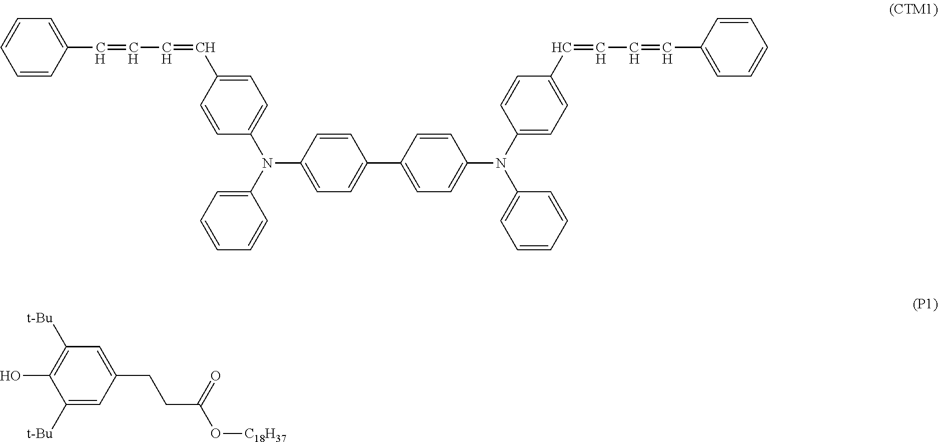

### (Analysis of Surface Layer of Electrophotographic Photosensitive Member)

Through the ¹H-nuclear magnetic resonance analysis in deuterated chloroform of a polymer component recovered from the surface layer of the resultant photosensitive member, a ¹H-NMR spectrum was obtained. The resultant ¹H-NMR spectrum had peaks at 2.21±0.02 ppm, 7.07±0.02 ppm, 7.11±0.02 ppm, and 7.13±0.02 ppm. As a result, it was identified that the surface layer of the photosensitive member included the structural unit represented by the formula (A1).

From the ¹H-NMR spectrum, the content in terms of mass % produced in a photosensitive member 1 was 100%. In addition, the content ratio in terms of mol % of the structural unit represented by the formula (A2) with respect to the structural unit represented by the formula (A1) was 0%.

### <Production of Photosensitive Member 2>

A photosensitive member 2 was produced in the same manner as in the photosensitive member 1 except that in the formation of the surface layer of the photosensitive member 2, the following materials were dissolved in a mixed solvent of 23 parts of ortho-xylene, 23 parts of methyl benzoate, and 23 parts of dimethoxymethane to prepare a coating liquid for a surface layer.
Charge-transporting material represented by the formula (CTM1): 55 parts
Charge-transporting material represented by the following formula (CTM2): 62 parts
Antioxidant represented by the formula (P1): 4 parts
Colorant represented by the following formula (P2): 1 part
Polyarylate resin including the structural unit represented by the formula (A1): 100 parts

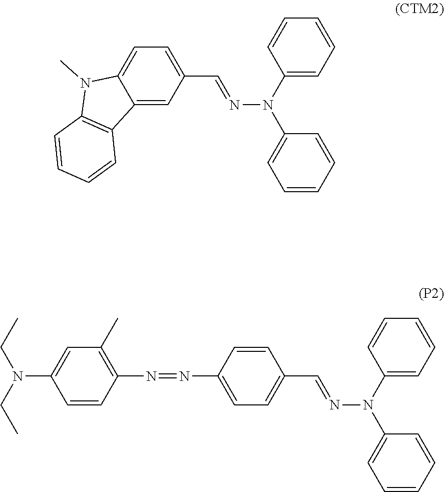

### <Production of Photosensitive Member 3>

A photosensitive member 3 was produced in the same manner as in the photosensitive member 1 except that in the formation of the surface layer of the photosensitive member 3, the following materials were dissolved in a mixed solvent of 23 parts of ortho-xylene, 23 parts of methyl benzoate, and 23 parts of dimethoxymethane to prepare a coating liquid for a surface layer.
Charge-transporting material represented by the following formula (CTM3): 58 parts
Charge-transporting material represented by the following formula (CTM4): 23 parts
Antioxidant represented by the formula (P1): 8 parts
Colorant represented by the formula (P2): 2 parts
Polyarylate resin including the structural unit represented by the formula (A1): 72 parts
Polycarbonate resin obtained by copolymerizing the following formula (A3) and the following formula (A4): 27 parts

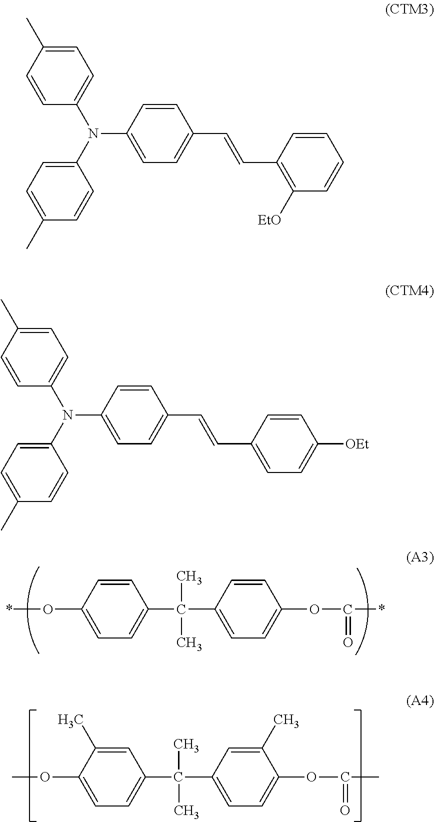

### <Production of Photosensitive Members 4 to 6 and 15>

Each of photosensitive members 4 to 6 and 15 was produced in the same manner as in the photosensitive member 3 except that the mixing ratio and the like were appropriately adjusted and changed as shown in Table 1 below in the production of the surface layer of each of the photosensitive members 4 to 6 and 15.

### <Production of Photosensitive Members 7 to 13>

Each of photosensitive members 7 to 13 was produced in the same manner as in the photosensitive member 1 except that the mixing ratio and the like were appropriately adjusted and changed as shown in Table 1 below in the production of the surface layer of each of the photosensitive members 7 to 13.

### <Production of Photosensitive Member 14>

A photosensitive member 14 was produced in the same manner as in the photosensitive member 2 except that the mixing ratio and the like were appropriately adjusted and changed as shown in Table 1 below in the production of the surface layer of the photosensitive member 14.

TABLE 1

| | Content mass [%] | |
|---|---|---|
| | of (A1) with respect | Content [mol %] |
| | to surface layer | of (A2) |
| Photosensitive member 1 | 57 | 0 |
| Photosensitive member 2 | 45 | 0 |
| Photosensitive member 3 | 57 | 0 |
| Photosensitive member 4 | 38 | 0 |
| Photosensitive member 5 | 53 | 0 |
| Photosensitive member 6 | 46 | 0 |
| Photosensitive member 7 | 30 | 15 |
| Photosensitive member 8 | 57 | 25 |
| Photosensitive member 9 | 57 | 30 |
| Photosensitive member 10 | 57 | 50 |
| Photosensitive member 11 | 57 | 70 |
| Photosensitive member 12 | 57 | 75 |
| Photosensitive member 13 | 57 | 90 |
| Photosensitive member 14 | 57 | 50 |
| Photosensitive member 15 | 45 | 50 |

### <Production of Photosensitive Member 16>

A photosensitive member 16 was produced in the same manner as in the photosensitive member 1 except that in the formation of the surface layer of the photosensitive member 16, the following materials were dissolved in a mixed solvent of 23 parts of ortho-xylene, 23 parts of methyl benzoate, and 23 parts of dimethoxymethane to prepare a coating liquid for a charge-transporting layer.
Charge-transporting material represented by the formula (CTM1): 69 parts
Antioxidant represented by the formula (P1): 7 parts
Polyarylate resin including a structural unit represented by the following formula (A5): 100 parts

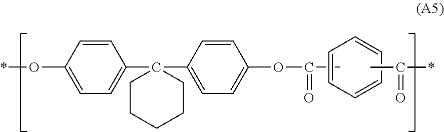

### <Production of Developing Roller 1>

### (Preparation of Substrate)

A mandrel made of stainless steel (SUS304) having an outer diameter of 6 mm and a length of 270 mm was prepared, and an electroconductive vulcanizing adhesive (product name: METALOC U-20, manufactured by Toyokagaku Kenkyusho Co., Ltd.) was applied to a circumferential surface of the mandrel, followed by baking, to thereby prepare a mandrel serving as a substrate.

### (Formation of First Elastic Layer)

Materials for elastic layers shown in Table 2 were mixed at a filling ratio of 70 vol % and a rotation speed of a blade of 30 rpm for 16 minutes with a 6-liter pressure kneader (product name: TD6-15M DX, manufactured by Toshin Co., Ltd.), to thereby provide a mixture A.

TABLE 2

| Material | Part(s) by mass |
|---|---|
| Acrylonitrile-butadiene rubber (NBR) | 60 |
| (product name: N230SV, manufactured by JSR | |
| Corporation) | |
| Epichlorohydrin rubber | 40 |
| (product name: EPION 301, manufactured by Osaka | |
| Soda Co., Ltd.) | |
| Zinc oxide (particle diameter: 0.28 μm, manufactured | 5 |
| by Sakai Chemical Industry Co., Ltd.) | |
| Calcium carbonate | 20 |
| (product name: NANOX #30, manufactured by | |
| Maruo Calcium Co., Ltd.) | |
| Carbon black | 40 |
| (product name: TOKABLACK #7400, manufactured | |
| by Tokai Carbon Co., Ltd.) | |

Then, materials shown in Table 3 were bilaterally cut 20 times in total at a front roll rotation speed of 10 rpm, a back roll rotation speed of 8 rpm, and a roll gap of 2 mm with an open roll having a roll diameter of 12 inches (0.30 m). After that, the resultant was subjected to tight milling 10 times at a roll gap of 0.5 mm, to thereby provide a mixture B.

TABLE 3

| Material | Part(s) by mass |
|---|---|
| Mixture A | 200 |
| Sulfur | 1.2 |
| Tetrabenzylthiuram disulfide | 4.5 |
| (product name: NOCCELER TBzTD, manufactured | |
| by Ouchi Shinko Chemical Industrial Co., Ltd.) | |

Next, the mixture B was extruded simultaneously with the mandrel while being molded into a cylindrical shape coaxially around the mandrel by extrusion molding using a crosshead, to thereby form a layer of the mixture B on the outer peripheral surface of the mandrel. An extruder having a cylinder diameter of 45 mm (Φ45) and an L/D of 20 was used as an extruder, and temperatures of a head, a cylinder, and a screw at the time of the extrusion were adjusted to 90° C., 90° C., and 90° C., respectively. Both end portions of the layer of the mixture B in the longitudinal direction of the mandrel were cut to set the length of the layer of the mixture B in the longitudinal direction of the mandrel to 237 mm.

After that, the mandrel was heated at a temperature of 160° C. for 40 minutes in an electric furnace to vulcanize the layer of the mixture B, to thereby form a vulcanized member. Then, the surface of the vulcanized member was polished with a polishing machine of a plunge-cut grinding mode. Thus, a roller in which a first elastic layer having a thickness of 3.0 mm was formed on the outer periphery of a metal core was obtained.

### (Formation of Second Elastic Layer)

As materials for a second elastic layer, materials except roughness-forming particles in Table 4 were stirred and mixed. After that, the materials were dissolved in methyl ethyl ketone (manufactured by Kishida Chemical Co., Ltd.) so that the solid content concentration was 30 mass %, mixed, and then uniformly dispersed with a sand mill. Methyl ethyl ketone was added to the mixed liquid to adjust the solid content concentration to 25 mass %, and the material shown in the “Roughness-forming particles” column of Table 4 was added to the resultant, followed by stirring and dispersion with a ball mill, to thereby provide a coating liquid for a second elastic layer. The coating liquid was applied to the roller having the first elastic layer formed thereon by dipping the roller into the coating liquid so that the thickness of the second elastic layer was about 15 m. After that, the resultant was heated at a temperature of 135° C. for 60 minutes to dry and cure the coating film, to thereby form a second elastic layer. As a result, a developing roller 1 was obtained.

TABLE 4

| | Part(s) |
|---|---|
| Material | by mass |
| Polyether polyol | 100 |
| (product name: PTGL1000, manufactured by | |
| Hodogaya Chemical Co., Ltd.) | |
| Polymeric MDI | 36.0 |
| (product name: MR-400, manufactured by | |
| Tosoh Corporation) | |
| Carbon black | 29.3 |
| (product name: SUNBLACK X15, manufactured | |
| by Asahi Carbon Co., Ltd.) | |
| Polyether monool | 3.0 |
| (product name: Newpol 50HB100, manufactured | |
| by Sanyo Chemical Industries, Ltd.) | |
| Modified silicone oil | 0.6 |
| (product name: TSF4445, manufactured by | |
| Momentive Performance Materials Japan LLC) | |
| Roughness-forming particles | 104 |
| (product name: DAIMIC BEAZ UCN-5090, | |
| manufactured by Dainichiseika Color & | |
| Chemicals Mfg. Co., Ltd.) | |

### (Analysis of Developing Roller 1)

A developing member was left under an environment of a temperature of 23° C. and a relative humidity of 53% for 24 hours. Next, measurement was performed at 12 points in 900 increments in a circumferential direction at positions of a center portion of the developing member and 20 mm inside from both end portions thereof with a micro rubber hardness meter (product name: MD-Icapa, manufactured by Kobunshi Keiki Co., Ltd.) using a push needle having a diameter of 0.16 mm, and an average of those measured values was used as an MD-1 hardness. The MD-1 hardness of the developing roller 1 was 50°.

### <Production of Developing Roller 2>

A developing roller 2 was produced in the same manner as in the developing roller 1 except that the parts by mass of carbon black of the mixture A in the first elastic layer was set to 30 parts. The MD-1 hardness of the surface of the resultant developing roller 2 is shown in Table 6.

### <Production of Developing Roller 3>

A developing roller 3 was produced in the same manner as in the developing roller 1 except that the parts by mass of zinc oxide of the mixture A in the first elastic layer was set to 14 parts. The MD-1 hardness of the surface of the resultant developing roller 3 is shown in Table 6.

### <Production of Developing Roller 4>

A developing roller 4 was produced in the same manner as in the developing roller 1 except that the first elastic layer was changed as described below. The MD-1 hardness of the surface of the resultant developing roller 4 is shown in Table 6.

### <Formation of First Elastic Layer>

As materials for the first elastic layer, an addition-type silicone rubber composition obtained by mixing materials shown in Table 5 with a kneader (product name: Trimix TX-15, manufactured by Inoue Mfg., Inc.) was injected into a mold heated to a temperature of 115° C. After the injection of the materials, the materials were molded while being heated at a temperature of 120° C. for 10 minutes, and the resultant was cooled to room temperature. Then, the resultant was removed from the mold to provide a roller having a first elastic layer with a thickness of 3.0 mm formed on the outer periphery of a metal core.

TABLE 5

| | Part(s) |
|---|---|
| Material | by mass |
| Liquid dimethylpolysiloxane | 100 |
| (product name: DMS-V46, viscosity: 60,000 cP, | |
| manufactured by Gelest, Inc.) | |
| Platinum-based catalyst | 0.048 |
| (product name: SIP6832.2, manufactured by | |
| Gelest, Inc.) | |
| Dimethylpolysiloxane | 2 |
| (product name: HMS-501, manufactured by | |
| Gelest, Inc.) | |
| Carbon black | 6 |
| (product name, TOKABLACK #7360SB, | |
| manufactured by Tokai Carbon Co., Ltd.) | |

### <Production of Developing Roller 5>

A developing roller 5 was produced in the same manner as in the developing roller 4 except that dimethylpolysiloxane of the first elastic layer was changed to HMS-082 (manufactured by Gelest, Inc.) and the parts by mass thereof were changed to 3 parts.

The MD-1 hardness of the surface of the resultant developing roller 5 is shown in Table 6.

### <Production of Developing Roller 6>

A developing roller 6 was produced in the same manner as in the developing roller 4 except that dimethylpolysiloxane of the first elastic layer was changed to HMS-082 (manufactured by Gelest, Inc.) and the parts by mass thereof were changed to 6 parts. The MD-1 hardness of the surface of the resultant developing roller 6 is shown in Table 6.

TABLE 6

| | MD-1 hardness [°] |
|---|---|
| Developing roller 1 | 50 |
| Developing roller 2 | 45 |
| Developing roller 3 | 55 |
| Developing roller 4 | 37 |
| Developing roller 5 | 20 |
| Developing roller 6 | 23 |

### <Production of Toner Supply Roller 1>

A primer (product name: DY39-012, manufactured by Dow Corning Toray Co., Ltd.) was applied to a metal core made of stainless steel (SUS304) having a diameter of 5 mm, followed by baking, to prepare a shaft body. In addition, a urethane rubber composition obtained by blending the following materials (A) to (F) and mixing the blended materials was foamed by a mechanical frothing method, to thereby produce a polyurethane foam.

The polyurethane foam was cut out into a 19-millimeter square rectangular parallelepiped shape having a length of 220 mm, and a shaft body insertion hole having a diameter of Φ5 mm was formed at the center of the 19-millimeter square surface along a longitudinal direction.

The shaft body was press-fitted into the shaft body insertion hole, and the shaft body and the polyurethane foam were bonded to each other by heat welding.

After that, the outer periphery of the polyurethane foam was polished with a traverse-type processing machine to produce an electroconductive roll having an outer diameter of 13 mm.
(A): Carbon black (Ketjen Black 600JD): 5.0 parts by mass
(B): Polyol A (polyethylene propylene ether triol having a number average molecular weight of 2,000, product name: ACTCOL EP-550N; manufactured by Mitsui Chemicals, Inc.): 100.0 parts by mass
(C): Polyisocyanate mixture (NCO %=45, MDI=20% content, product name: COSMONATE TM20; manufactured by Mitsui Chemicals, Inc.): 24.4 parts by mass
(D): Silicone foam stabilizer (product name: SRX274C, manufactured by Dow Corning Toray Silicone Co., Ltd.): 1.0 part by mass
(E): Tertiary amine catalyst A (mixture of bis(2-dimethylaminoethyl) ether and dipropylene glycol, product name: TOYOCAT-ET, manufactured by Tosoh Corporation): 0.3 part by mass
(F): Amine catalyst B (product name: TOYOCAT-L33, manufactured by Tosoh Corporation): 0.2 part by mass

### <Production of Toner Supply Roller 2>

A primer (product name: DY39-012, manufactured by Dow Corning Toray Co., Ltd.) was applied to a metal core made of stainless steel (SUS304) having a diameter of 5 mm, followed by baking, to prepare a shaft body.

In addition, the following materials (A) to (D) were blended and sufficiently kneaded with a two-spindle roll to provide a rubber composition.
(A): Millable-type silicone rubber (KE-3601SB-U, manufactured by Shin-Etsu Chemical Co., Ltd.): 100 parts by mass
(B): White catalyst (C-25A, manufactured by Shin-Etsu Chemical Co., Ltd.): 1.0 part by mass
(C): Cross-linking agent (C-25B, manufactured by Shin-Etsu Chemical Co., Ltd.): 2.5 parts by mass
(D): Chemical foaming agent (AIBN, manufactured by Otsuka Chemical Co., Ltd.): 10 parts by mass

The shaft body and the rubber composition were extruded in one piece with an extrusion molding machine, and the rubber composition was primarily vulcanized by heating at 230° C. for 20 minutes in an infrared heating furnace, followed by secondary vulcanization at 230° C. for 7 hours in a hot air drying furnace, to thereby produce a roller base body having a foamed layer. The outer periphery of the roller base body was polished with a traverse-type processing machine to produce an electroconductive roll having an outer diameter of 13 mm.

### <Production of Toner Supply Roller 3>

A toner supply roller 3 was produced in the same manner as in the toner supply roller 1 except that the electroconductive filler was changed from carbon black to an ionic electroconductive material (lithium N,N-bis(trifluoromethanesulfonyl)imide (product name: EF-N115, manufactured by Mitsubishi Materials Electronic Chemicals Co., Ltd.; 5 parts by mass).

### [Evaluation]

### <Evaluation of Fluctuation in Dynamic Friction Coefficient (Evaluation (1))>

The dynamic friction coefficient between a developing roller and an electrophotographic photosensitive member was measured with a surface property measuring device (product name: Heidon: Type 14, manufactured by Shinto Scientific Co., Ltd.), and a fluctuation in dynamic friction coefficient was evaluated. A jig of the measuring device was modified so that the developing roller was able to be brought into abutment against the electrophotographic photosensitive member, and a vertical load of 60 g was applied with a weight. The electrophotographic photosensitive member was rotated at a speed of 310 rpm with a mechanism that rotatably supports the electrophotographic photosensitive member, which was prepared separately from the measuring device, to thereby measure a dynamic friction coefficient.

The fluctuation in dynamic friction coefficient was calculated as a change ratio B/A×100 of the dynamic friction coefficient in the presence or absence of an increase in temperature when the dynamic friction coefficient measured in the developing roller at room temperature was represented by A and the dynamic friction coefficient measured in the developing roller heated to a surface temperature of 40° C. assuming an increase in temperature was represented by B.

<Evaluation of Occurrence Situation of Banding Image after Repeated Use Under Room Temperature Environment (Evaluation (2))>

A charging potential and an exposure potential were set to −550 V and −100 V, respectively, under an environment of a temperature of 23° C. and a relative humidity of 50%, and 10,000 sheets were continuously passed so that a halftone image drawing horizontal lines with a width of one dot and an interval of two dots in a direction perpendicular to the rotation direction of the photosensitive member was printed on the sheets. In this case, a reconstructed product of a laser beam printer manufactured by Hewlett-Packard Company may be used as an electrophotographic apparatus to be used. Specific examples thereof include Color Laser Jet Enterprise M653dn (product name), Color Laser Jet Enterprise M553dn (product name), and Color Laser Jet CP4525dn (product name). The evaluation was performed by visually observing the occurrence situation of streak-like unevenness in the halftone images, and the determination was performed based on the following criteria.

TABLE 7

| | Evaluation results |
|---|---|
| A | No horizontal streak-like unevenness is recognized. |
| B | Horizontal streak-like unevenness is slightly recognized. |
| C | Horizontal streak-like unevenness is recognized at the position |
| | corresponding to the rotation pitch of the charging roller. |
| D | Horizontal streak-like unevenness is significantly observed. |

<Evaluation of Occurrence Situation of Banding Image after Repeated Use Under Low-Temperature and Low-Humidity Environment (Evaluation (3))>

In the same manner as in Evaluation (2), a paper passing endurance test of 10,000 sheets was performed under a low-temperature and low-humidity environment (temperature: 15° C., relative humidity: 10%). After the passage of 10,000 sheets, the images were evaluated in the same manner as in Evaluation (2), and the determination was performed based on the above-mentioned criteria.

### Example 1

The electrophotographic photosensitive member 1 and the developing roller 1 produced as described above were mounted on Heidon: Type 14 modified as described above, and Evaluation (1) was performed.

In a process cartridge, a counter configuration was adopted and a coupling, an intermediate, and gears were arranged as illustrated in FIG. 3 so that a driving force was input to an axial end portion of a toner supply roller (hereinafter referred to as “RS input configuration”). In addition, the arrangement of the coupling, the intermediate, and the gears, and the setting of the gear ratio of the respective gears, the radius r_{D} of the developing roller, and the radius r_{RS} of the toner supply roller were adjusted so as to satisfy R=1.25. Regarding the rotational angular velocity ω_{D} of the developing roller used here and the rotational angular velocity ω_{RS} of the toner supply roller used here, the gear ratio of various gears was set so that λ represented by the following formula (E2) was 1.12.

λ=ω_{RS}/ω_{D} (E2)

In addition, the radius r_{D} of the developing roller used here was 12.00 [mm], and the radius r_{RS} of the toner supply roller was 13.35 [mm]. When those values are used, the relationship of λ×r_{RS}/r_{D}=1.25 is obtained, and the condition of 1.2≤λ×r_{RS}/r_{D}≤1.5 is satisfied. The electrophotographic photosensitive member 1, the developing roller 1, and the toner supply roller 1 produced in the foregoing were mounted on the process cartridge, and Evaluations (2) and (3) were performed. The results thereof are shown in Table 8.

### Examples 2 to 14 and 16 to 26

Evaluation was performed in the same manner as in Example 1 except that each combination of the electrophotographic photosensitive member, the developing member, and the R was changed as shown in Table 8. The evaluation results are shown in Table 8.

### Example 15

Evaluation was performed in the same manner as in Example 1 except that a coupling, an intermediate, and gears were arranged as illustrated in FIG. 4 so that a driving force from outside was input to an end portion of a mandrel of a developing roller (hereinafter referred to as “D input configuration”). The evaluation results are shown in Table 8.

### Comparative Examples 1 to 3

Evaluation was performed in the same manner as in Example 1 except that each combination of the electrophotographic photosensitive member, the developing roller, the toner supply roller, and the R was changed as shown in Table 9. The evaluation results are shown in Table 9. In any of Comparative Examples, a dynamic friction coefficient was changed due to an increase in temperature, and a streak-like defective image was conspicuous.

TABLE 8

| | | | | | | Evaluation | | |
|---|---|---|---|---|---|---|---|---|
| | | | | | | (1) | Evaluation | Evaluation |
| Example No. | R | λ | Photosensitive member | Developing roller | Toner supply roller | B/A | (2) | (3) |
| Example 1 | 1.25 | 1.12 | Photosensitive member 1 | Developing roller 1 | Toner supply roller 1 | 99% | A | B |
| Example 2 | 1.25 | 1.12 | Photosensitive member 2 | Developing roller 1 | Toner supply roller 1 | 99% | A | B |
| Example 3 | 1.25 | 1.12 | Photosensitive member 1 | Developing roller 2 | Toner supply roller 1 | 102% | A | B |
| Example 4 | 1.25 | 1.12 | Photosensitive member 1 | Developing roller 3 | Toner supply roller 1 | 100% | A | B |
| Example 5 | 1.25 | 1.12 | Photosensitive member 1 | Developing roller 4 | Toner supply roller 1 | 108% | B | C |
| Example 6 | 1.25 | 1.12 | Photosensitive member 1 | Developing roller 5 | Toner supply roller 1 | 104% | B | B |
| Example 7 | 1.25 | 1.12 | Photosensitive member 1 | Developing roller 6 | Toner supply roller 1 | 107% | B | C |
| Example 8 | 1.25 | 1.12 | Photosensitive member 3 | Developing roller 2 | Toner supply roller 1 | 99% | A | B |
| Example 9 | 1.25 | 1.12 | Photosensitive member 4 | Developing roller 2 | Toner supply roller 1 | 102% | B | B |
| Example 10 | 1.25 | 1.12 | Photosensitive member 5 | Developing roller 2 | Toner supply roller 1 | 103% | B | C |
| Example 11 | 1.25 | 1.12 | Photosensitive member 6 | Developing roller 2 | Toner supply roller 1 | 109% | B | C |
| Example 12 | 1.2 | 1.08 | Photosensitive member 2 | Developing roller 2 | Toner supply roller 1 | 99% | A | A |
| Example 13 | 1.4 | 1.26 | Photosensitive member 2 | Developing roller 2 | Toner supply roller 1 | 99% | B | C |
| Example 14 | 1.5 | 1.35 | Photosensitive member 2 | Developing roller 2 | Toner supply roller 1 | 99% | B | C |
| Example 15 | 1.25 | 1.12 | Photosensitive member 2 | Developing roller 2 | Toner supply roller 1 | 99% | B | B |
| Example 16 | 1.25 | 1.12 | Photosensitive member 7 | Developing roller 2 | Toner supply roller 1 | 105% | B | C |
| Example 17 | 1.25 | 1.12 | Photosensitive member 8 | Developing roller 2 | Toner supply roller 1 | 103% | B | C |
| Example 18 | 1.25 | 1.12 | Photosensitive member 9 | Developing roller 2 | Toner supply roller 1 | 100% | A | A |
| Example 19 | 1.25 | 1.12 | Photosensitive member 10 | Developing roller 2 | Toner supply roller 1 | 100% | A | A |
| Example 20 | 1.25 | 1.12 | Photosensitive member 11 | Developing roller 2 | Toner supply roller 1 | 100% | A | A |
| Example 21 | 1.25 | 1.12 | Photosensitive member 12 | Developing roller 2 | Toner supply roller 1 | 104% | B | C |
| Example 22 | 1.25 | 1.12 | Photosensitive member 13 | Developing roller 2 | Toner supply roller 1 | 108% | B | C |
| Example 23 | 1.25 | 1.12 | Photosensitive member 14 | Developing roller 2 | Toner supply roller 1 | 100% | A | A |
| Example 24 | 1.25 | 1.12 | Photosensitive member 15 | Developing roller 2 | Toner supply roller 1 | 100% | A | A |
| Example 25 | 1.25 | 1.12 | Photosensitive member 1 | Developing roller 2 | Toner supply roller 2 | 100% | B | C |
| Example 26 | 1.25 | 1.12 | Photosensitive member 1 | Developing roller 2 | Toner supply roller 3 | 100% | C | C |

TABLE 9

| | | | | | | Evaluation | | |
|---|---|---|---|---|---|---|---|---|
| Comparative Example | | | | | | (1) | Evaluation | Evaluation |
| No. | R | λ | Photosensitive member | Developing roller | Toner supply roller | B/A | (2) | (2) |
| Comparative Example 1 | 1.6 | 1.44 | Photosensitive member 1 | Developing roller 2 | Toner supply roller 1 | 100% | D | D |
| Comparative Example 2 | 1.1 | 0.98 | Photosensitive member 1 | Developing roller 2 | Toner supply roller 1 | 100% | D | D |
| Comparative Example 3 | 1.25 | 1.12 | Photosensitive member 16 | Developing roller 2 | Toner supply roller 1 | 115% | C | D |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-075154, filed Apr. 28, 2023, Japanese Patent Application No. 2023-184122, filed Oct. 26, 2023, and Japanese Patent Application No. 2024-037339, filed Mar. 11, 2024, which are hereby incorporated by reference herein in their entirety.

What is claimed is:

1. A process cartridge being detachably attachable onto a main body of an electrophotographic apparatus,
the process cartridge comprising:
an electrophotographic photosensitive member;
a developing roller configured to develop an electrostatic latent image formed on a surface of the electrophotographic photosensitive member; and
a toner supply roller arranged in contact with the developing roller and configured to supply toner to the developing roller,
wherein the developing roller and the toner supply roller are configured so that a movement direction of a surface of the developing roller and a movement direction of a surface of the toner supply roller at the time of operation are opposite to each other at a contact position of the developing roller and the toner supply roller, and the developing roller and the toner supply roller are configured to be rotated so that R represented by the following formula (E1) satisfies 1.2≤R≤1.5:
$$R = {V}_{RS} / {V}_{D} \qquad ( E1 )$$
in the formula (E1), V_{RS} represents an absolute value of a peripheral speed [m/s] of the toner supply roller, and V_{D} represents an absolute value of a peripheral speed [m/s] of the developing roller,
wherein the surface of the developing roller is a surface of an elastic layer,
wherein the toner supply roller includes a shaft body and a resin layer formed on an outer peripheral surface of the shaft body, and
wherein the electrophotographic photosensitive member includes a surface layer containing a polyarylate resin including a structural unit represented by the following formula (A1).

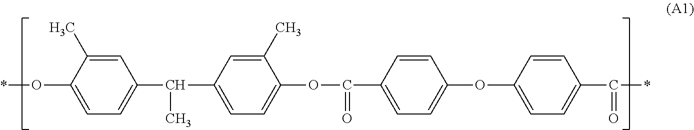

2. The process cartridge according to claim 1, wherein a ¹H-nuclear magnetic resonance spectrum obtained by subjecting a polymer component recovered from the surface layer of the electrophotographic photosensitive member to ¹H-nuclear magnetic resonance analysis in deuterated chloroform has peaks at 2.21±0.02 ppm, 7.07±0.02 ppm, 7.11±0.02 ppm, and 7.13±0.02 ppm.

3. The process cartridge according to claim 1, wherein a content of the polyarylate resin including the structural unit represented by the formula (A1) in the surface layer of the electrophotographic photosensitive member is 45 mass % or more with respect to a total mass of the surface layer.

4. The process cartridge according to claim 1 further comprising:
a driving force-receiving portion configured to receive a driving force for driving the toner supply roller;
a first driving force-transmitting portion configured to transmit the driving force received by the driving force-receiving portion to the toner supply roller; and
a second driving force-transmitting portion configured to transmit a driving force generated by drive of the toner supply roller to the developing roller.

5. The process cartridge according to claim 4,
wherein the second driving force-transmitting portion includes a third driving force-transmitting portion, a fourth driving force-transmitting portion, and a fifth driving force-transmitting portion,
wherein the third driving force-transmitting portion is arranged in an end portion of the shaft body of the toner supply roller, and is configured to transmit the driving force generated by drive of the toner supply roller to the fourth driving force-transmitting portion,
wherein the fourth driving force-transmitting portion is configured to transmit a driving force to the fifth driving force-transmitting portion by being driven with the driving force received from the third driving force-transmitting portion, and
wherein the fifth driving force-transmitting portion is arranged in an end portion of a mandrel of the developing roller, and is configured to receive the driving force from the fourth driving force-transmitting portion to drive the developing roller.

6. The process cartridge according to claim 4, wherein when a radius of the developing roller is represented by r_{D} [mm], and a radius of the toner supply roller is represented by r_{RS} [mm], the toner supply roller, the second driving force-transmitting portion, and the developing roller are driven to be coupled so that λ represented by the following formula (E2) satisfies 1.2≤λ×r_{RS}/r_{D}≤1.5:
$$λ = {ω}_{RS} / {ω}_{D} \qquad ( E2 )$$
in the formula (E2), ω_{RS} represents a rotational angular velocity [rad/s] of the toner supply roller, and ω_{D} represents a rotational angular velocity [rad/s] of the developing roller.

7. The process cartridge according to claim 1, wherein the R satisfies 1.2≤R≤1.3.

8. The process cartridge according to claim 1, wherein the surface of the developing roller has an MD-1 hardness of 20° or more and 550 or less.

9. The process cartridge according to claim 1, wherein the resin layer is a foamed layer.

10. The process cartridge according to claim 1, wherein the resin layer contains a polyurethane resin as a binder resin.

11. The process cartridge according to claim 1, wherein the resin layer contains an electronic electroconductive filler.

12. The process cartridge according to claim 1, wherein the polyarylate resin includes structural units to be a copolymer of the formula (A1) and the following formula (A2).

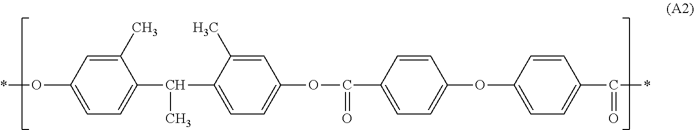

13. The process cartridge according to claim 12, wherein a content mol % of the structural unit represented by the formula (A2) with respect to the structural unit represented by the formula (A1) in the polyarylate resin is 30 mol % or more and 70 mol % or less.

14. An electrophotographic apparatus comprising a process cartridge,
the process cartridge being detachably attachable onto a main body of the electrophotographic apparatus,
the process cartridge including:
an electrophotographic photosensitive member;
a developing roller configured to develop an electrostatic latent image formed on a surface of the electrophotographic photosensitive member; and
a toner supply roller arranged in contact with the developing roller and configured to supply toner to the developing roller,
wherein the developing roller and the toner supply roller are configured so that a movement direction of a surface of the developing roller and a movement direction of a surface of the toner supply roller at the time of operation are opposite to each other at a contact position of the developing roller and the toner supply roller, and the developing roller and the toner supply roller are configured to be rotated so that R represented by the following formula (E1) satisfies 1.2≤R≤1.5.
$$R = {V}_{RS} / {V}_{D} \qquad ( E1 )$$
in the formula (E1), V_{RS} represents an absolute value of a peripheral speed [m/s] of the toner supply roller, and V_{D} represents an absolute value of a peripheral speed [m/s] of the developing roller,
wherein the surface of the developing roller is a surface of an elastic layer, wherein the toner supply roller includes a shaft body and a resin layer formed on an outer peripheral surface of the shaft body, and
wherein the electrophotographic photosensitive member includes a surface layer containing a polyarylate resin including a structural unit represented by the following formula (A1). [chemical structure]
